(19) United States
(12) Patent Application Publication
(10) Pub. No.: US 2002/0072352 A1
(43) Pub. Date: Jun. 13, 2002

(54) Method and apparatus for querying the status of mobile subscibers

(76) Inventors: Rittwik Jana, Pinebrook, NJ (US); Theodore Johnson, New York, NY (US); Shanmugavelayutham Muthukrishnan, Washington, DC (US)

Correspondence Address: Samuel H. Dworetsky, AT&T CORP., P.O. Box 4110, Middletown, NJ, 07748-4110, US

(21) Appl. No.: 09/735,885

(22) Filed: Dec. 13, 2000

(51) Int. Cl. H04Q 7/20

(52) U.S. Cl. 455/414; 455/433; 455/426

(57) ABSTRACT

Wireless communication companies can enhance the user experience of their mobile subscribers by providing information about the status of their connection to data service providers. The present invention covers a mechanism for providing this information (presence, location, etc.) to data service providers and to customers, by using infrastructure developed for customer care applications. As a result, the infrastructure required to provide these services can be implemented and maintained at a lower cost than a specially designed infrastructure.

### FIELD OF THE INVENTION

The present invention relates generally to mobile telecommunication services, and more particularly to status information services for mobile subscribers.

### BACKGROUND OF THE INVENTION

Many data service applications have been developed which can use information about the current status of a mobile subscriber (MS) on a wireless network. For example, instant message services are enhanced by “presence information (e.g., whether or not the MS device is reachable from the wireless network). In another example, data services such as yellow page services are enhanced with “location” information (e.g., to provide directory listings of businesses that are physically close to the MS). There are many additional applications of presence and location information, and other types of information might be valuable at a future date.

While the telephone networks store this information about its wireless subscribers, the networks have not been designed to provide this information to new applications, such as instant messaging or third party data services. A variety of mechanisms have been proposed to make this information available to advanced applications. See, e.g., Technical Specification Group Core Network, “Location Management Procedures,” 3G TS 23.012, 3^{rd} Generation Partnership Project; Technical Specification Group Services and System Aspects, “Location Services (LCS),” 3G TS 22.071, 3^{rd} Generation Partnership Project. However, the primary disadvantage of the prior art mechanisms is the increased cost due to the need to install and maintain additional network infrastructure.

Wireless carriers typically have a customer care application that can query this information, in order to quickly resolve customer problems. This application typically contains modules that query network elements and return a variety of information about the MS in question, including but not limited to the Home Location Register (HLR) of the MS, the subscription status of the MS, the presence status of the MS (available, on a call, unavailable, etc.), the current Mobile Switching Center (MSC) of the MS, the current or last registered cell site of the MS and the time of the last registration, MS signal strength information, the number that a MS has called or the number that called the MS, and MSC and cell site usage. This information is valuable for diagnosing and resolving customer problems.

### SUMMARY OF THE INVENTION

Wireless communication companies can enhance the user experience of their mobile subscribers by providing information about the status of their connection to data service providers. The present invention covers a mechanism for providing this information (e.g. presence, location, etc.) to data service providers and to customers, by using infrastructure developed for customer care applications. As a result, the infrastructure required to provide these services can be implemented and maintained at a lower cost than a specially designed infrastructure.

These and other advantages of the invention will be apparent to those of ordinary skill in the art by reference to the following detailed description and the accompanying drawings.

### BRIEF DESCRIPTION OF THE DRAWINGS

FIG. 1 is a network diagram illustrating various embodiments of the present invention.

FIG. 2 is a flow chart illustrating a method of ascertaining the location of a subscriber's mobile unit, in accordance with an embodiment of the present invention.

FIG. 3 is a flow chart illustrating a method of ascertaining the location of a subscriber's mobile unit, in accordance with another embodiment of the present invention.

FIG. 4 is a flow chart illustrating a method of ascertaining presence information regarding a subscriber, in accordance with an embodiment of the present invention.

FIG. 5 is a flow chart illustrating a method of ascertaining presence information regarding a subscriber, in accordance with another embodiment of the present invention.

### DETAILED DESCRIPTION

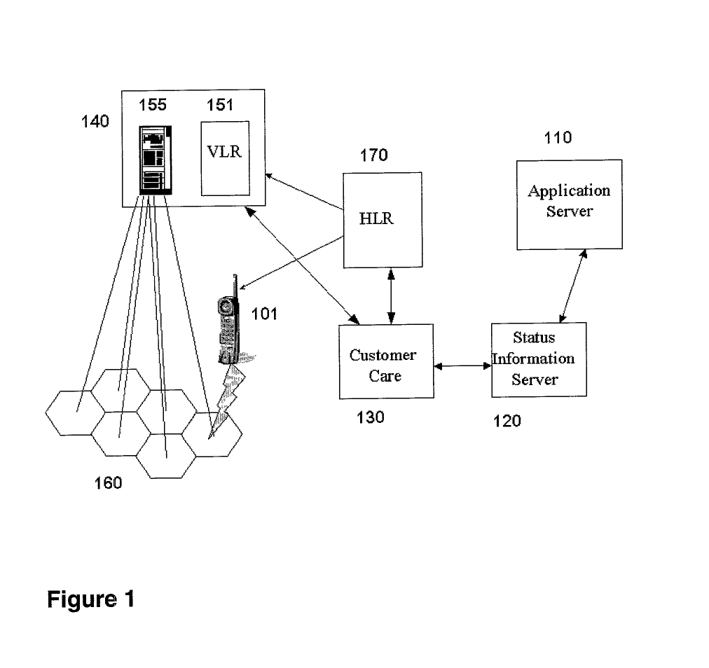

FIG. 1 sets forth a diagram of a specific implementation illustrating various embodiments of the present invention. A mobile subscriber (MS) has access to a mobile unit 101, depicted in FIG. 1 as a cellular radiotelephone. The mobile subscriber roams through a plurality of cell sites 160 served by a mobile telephone switching office (MTSO) 140 which further comprises a visiting location register (VLR) 151, and a switch box 155, as is known in the art. The cellular switch is a high-speed computer that connects voice communication paths for completing calls across the mobile network. The VLR provides information about mobile subscribers “visiting” the particular region serviced by the MTSO. A Home Location Register (HLR) 170 stores MS account status and tracks the current MSTO of the MS. The HLR is a collection of one or more high-performance network databases that contains information about each subscriber in a particular “home” region, including the services they subscribe to. The mobile network also comprises a customer care server 130 (physically comprised of one or more computers) which has direct access to the HLR and MTSO systems in order to immediately correct or obtain information on customer issues. The particular customer care infrastructure utilized will vary significantly from mobile service provider to mobile service provider. In the context of the present invention, it is advantageous if the customer care infrastructure has an application programming interface that permits remote queries of status information pulled from the HLR or the MTSO and served using some standard communication protocol such as HTTP.

For example, the customer care infrastructure could be a dedicated Internet Protocol (IP) based network connecting the customer care server 130 to the MTSOs and the HLRs using a standard remote access protocol such as telnet. Typical customer care infrastructures include the following mechanisms for communicating with the HLRs and the MTSOs. A database is typically provided which describes how to access the HLRs and the MTSOs. This information usually includes mappings from phone numbers to HLRs as well as Internet Protocol (IP) addresses and port numbers, proper security passwords and descriptions of how to process the telnet login screen information and parse responses. A layer of software must be provided to enable the login, the posting of queries, and the interpreting of responses. Finally, mechanisms must be in place to facilitate the maintenance required to keep the databases in synchronization, maintain dedicated networks, keep login procedures the same at mated pairs of HLRs, etc. The customer care server 130, in accordance with a preferred embodiment of the present invention, is a web server capable of utilizing the above mechanisms to serve specialized status information requests in addition to traditional customer care requests issued by specialized customer care clients.

In accordance with an embodiment of the present invention, a status information server 120 has access to the customer care server 130 and can issue specialized queries to the customer care server 130. The specialized status information queries can be enabled by enhancing the software on the customer care server 130, e.g. by creating a new servlet where the server software is a Java-enabled web server. The status information server 120 advantageously utilizes an automatic authentication mechanism, rather than the typical security procedures for the customer care infrastructure (e.g. a login and password for each customer care representative). An application service server 110 accesses the status information server and can request that the status information be utilized in the context of the particular services rendered by server 110.

For example, server 110 can offer a “where am I” service. A MS subscriber calls a phone number which connects the user to an Interactive Voice Response (IVR) server 110. Server 110 collects the telephone number of the MS, using caller ID. The server 110 contacts the status information server 120, in this example a location server for the voice link, with the phone number of the MS. After conducting a successful authentication procedure, the location server 120 issues a special location query to the enhanced customer care server 130. The enhanced customer care server 130 queries the network elements and responds to location server 120 with the location of the user. After additional authentication, location server 120 responds to IVR server 110 with the location of the caller. IVR server 110 composes a response indicating the location of the MS and responds to the user via text to speech technology.

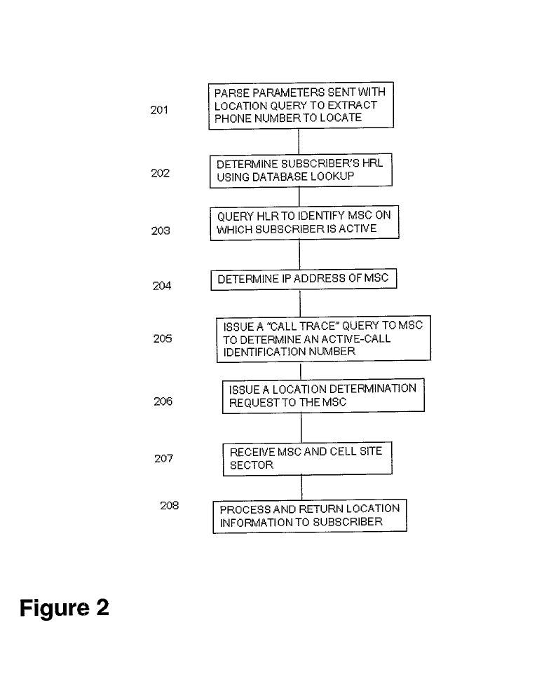

In accordance with an embodiment of the present invention, the location query is received by the enhanced customer care server 130 and processed in a manner such as set forth in FIG. 2. The process set forth in FIG. 2 can be enabled by a specialized software application running on the customer care server 130, such as a Java servlet running on a Java-enabled web server. At step 201, the location query is received and the location servlet invoked, e.g. by HTTP. The parameters of the location query are parsed (e.g., by examining the URL of the HTTP request) and a telephone number extracted to be located. At step 202, the subscriber's HLR is determined by a database lookup using the telephone number extracted at step 201. At step 203, the HLR is queried to identify the MTSO on which the particular subscriber is active. At step 204, the address of the MTSO is determined; where the customer care infrastructure is an IP network, the MTSO will have an IP address which the servlet can utilize to access the MTSO. At step 205, the servlet can issue a “call trace” query to the MTSO to determine the active-call identification number. Using the active-call identification number, the MTSO can then issue a location determination request to the MTSO at step 206. The response from the MTSO, e.g. the MTSO identifier, the cell site/sector, can then be processed and returned to the location server at step 207. The location server and application service server can then process the location information at step 208 (e.g., by matching the MTSO identifier and cell site/sector to a geographic location) and return the results to the application server.

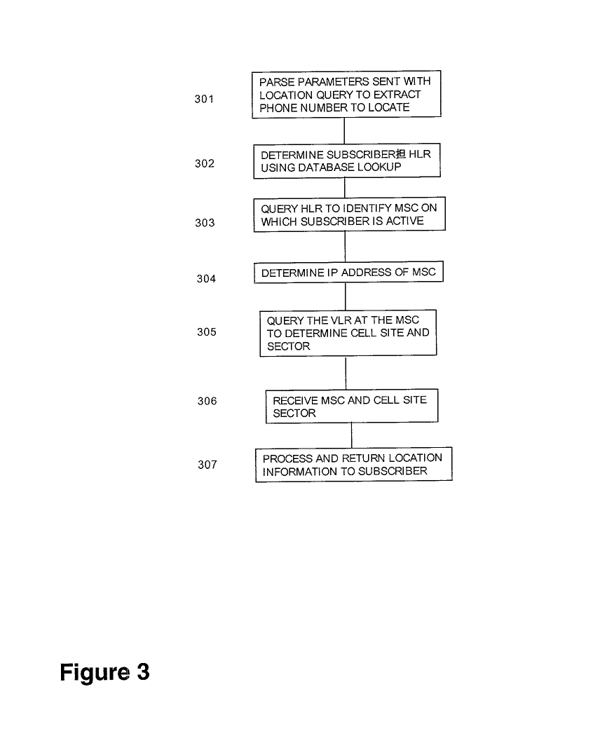

In another embodiment of the present invention, the location query is received by the enhanced customer care server 130 and processed in a manner such as set forth in FIG. 3. The process set forth in FIG. 3 can be enabled by a specialized software application running on the customer care server 130, such as a Java servlet running on a Java-enabled web server. At step 301, the location query is received and the location servlet invoked, e.g. by HTTP. The parameters of the location query are parsed (e.g., by examining the URL of the HTTP request) and a telephone number extracted to be located. At step 302, the subscriber's HLR is determined by a database lookup using the telephone number extracted at step 301. At step 303, the HLR is queried to identify the MTSO on which the particular subscriber is active. At step 304, the address of the MTSO is determined; where the customer care infrastructure is an IP network, the MTSO will have an IP address which the servlet can utilize to access the MTSO. At step 305, the servlet can issue a query to the VLR at the MTSO, requesting the subscriber's current location. The response from the MTSO, e.g. the MTSO identifier, the cell site/sector, can then be processed and returned to the location server at step 306. The location server and application service server can then process the location information at step 307 (e.g., by matching the MTSO identifier and cell site/sector to a geographic location) and return the results to the application server.

Thus, the customer care server 130 is able to extract the subscriber telephone number from the location query and to issue a request for the subscriber's HLR that corresponds to the subscriber's telephone number. The customer care server 130 has a component that is capable of parsing the result of the HLR request and a database that maps the MTSO identifier returned by the HLR query to a MTSO identifier stored in the customer care databases. The customer care server 130 has a component that is capable of parsing the results of the call trace on the MTSO and a component which ultimately issues and parses the location determination response. Alternatively, the customer care server 130 has a component which queries the VLR on the MTSO, and which parses the location determination response.

For another example, server 110 can be a component of an Instant Messaging (IM) system. The IM server 110 queries status information server 120 requesting presence information about a MS with a specific phone number. After conducting a successful authentication procedure, presence server 120 issues a special presence query to the enhanced customer care server 130. The enhanced customer care server 130 queries the network elements and responds to presence server 120 with the presence status of the user. After additional authentication, presence server 120 responds to IM server 110 with the presence status of the indicated subscriber.

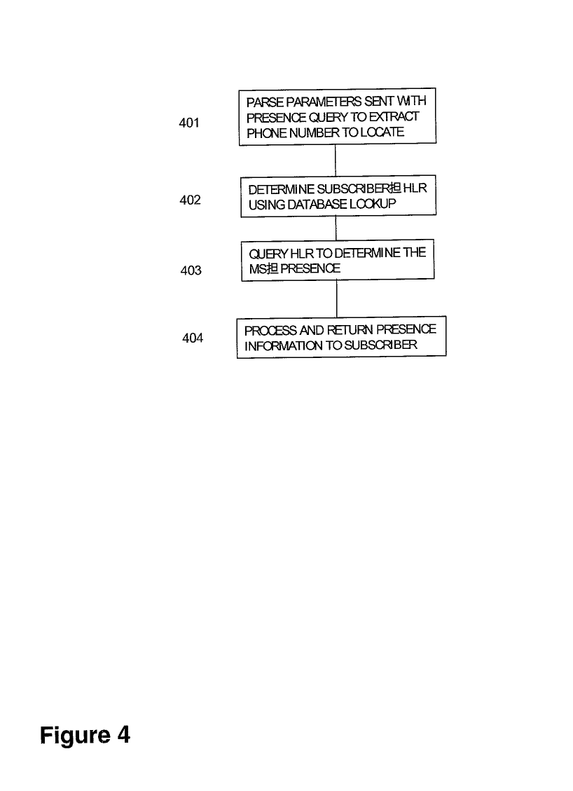

In accordance with an embodiment of the present invention, the presence query is received by the enhanced customer care server 130 and processed in a manner such as set forth in FIG. 4. The process set forth in FIG. 4 can be enabled by a specialized software application running on the customer care server 130, such as a Java servlet running on a Java-enabled web server. At step 401, the presence query is received and the presence servlet invoked, e.g. by HTTP. The parameters of the presence query are parsed (e.g., by examining the URL of the HTTP request) and a telephone number extracted. At step 402, the subscriber's HLR is determined by a database lookup using the telephone number extracted at step 401. At step 403, the HLR is queried for the user's presence information. In step 404, the subscriber's MS presence status information is returned to the IM server.

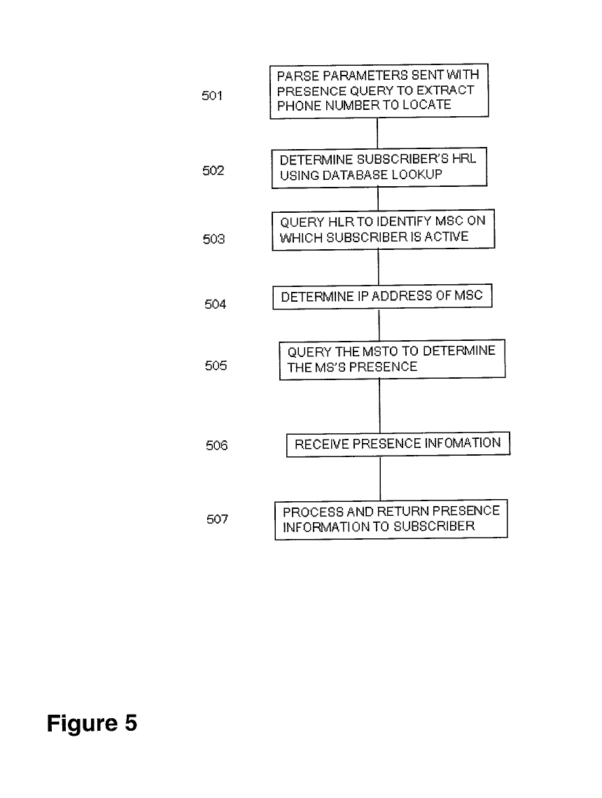

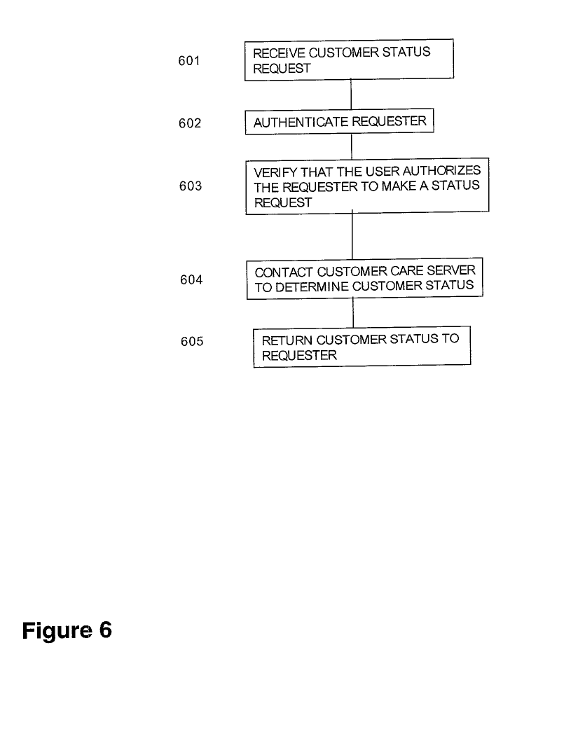

The MSTO might contain enhanced presence status information about an MS (for example, determining whether the subscriber is currently on a voice call in addition). In another embodiment of the present invention, the presence query is received by the enhanced customer care server 130 and processed in a manner such as set forth in FIG. 5. The process set forth in FIG. 5 can be enabled by a specialized software application running on the customer care server 130, such as a Java servlet running on a Java-enabled web server. At step 501, the presence query is received and the presence servlet invoked, e.g. by HTTP. The parameters of the presence query are parsed (e.g., by examining the URL of the HTTP request) and a telephone number extracted. At step 502, the subscriber's HLR is determined by a database lookup using the telephone number extracted at step 501. At step 503, the HLR is queried to identify the MTSO on which the particular subscriber is active. At step 504, the address of the MTSO is determined; where the customer care infrastructure is an IP network, the MTSO will have an IP address which the servlet can utilize to access the MTSO. At step 505, the MSTO is queried for the user's presence information. In step 506, the subscriber's MS presence status information is returned to the IM server.

The Status Information server 120 might interact with the Application server 110 and the Customer Care server 130 in the manner shown in FIG. 6. At step 601, the Status Information server receives a customer status request from the Application server 110 via a protocol such as HTTP. At step 602, the identity of the requesting server is authenticated. At step 603, the Status Information server 120 verifies that the user has authorized the requesting Application server to make status information queries about that user. At step 604, the Status Information server 120 contacts the Customer Care server 130 via a protocol such as HTTP to obtain status information about the customer. At step 605, the status information is formatted and transmitted to the requesting Application server.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

What is claimed is:

1. A status information service for a mobile telecommunication network comprising:
customer care infrastructure in communication with the mobile telecommunication network and adapted to answer status information queries; and
a subscriber status information server adapted for use with the customer care infrastructure and capable of issuing status information queries to the customer care infrastructure.

2. The invention of claim 1 wherein the status information comprises information indicating location of a subscriber

3. The invention of claim 2 wherein the customer care infrastructure is further adapted to
parse a status information query for subscriber information;
determine a subscriber's home location register from the subscriber information;
query the subscriber's home location register to identify the mobile telephone switching office on which the subscriber is active;
issue a call trace query to the mobile telephone switching office; and
receive and process location information from the mobile telephone switching office.

4. The invention of claim 2 wherein the customer care infrastructure is further adapted to
parse a status information query for subscriber information;
determine a subscriber's home location register from the subscriber information;
query the subscriber's home location register to identify the mobile telephone switching office on which the subscriber is active;
query a visiting location register at the mobile telephone switching office; and
receive and process location information from the mobile telephone switching office.

5. The invention of claim 1 wherein the status information comprises information indicating presence of a subscriber

6. The invention of claim 5 wherein the customer care infrastructure is further adapted to
parse a status information query for subscriber information;
determine a subscriber's home location register from the subscriber information;
query the subscriber's home location register for subscriber presence information;
receive and process location information from the subscriber's home location register.

7. The invention of claim 5 wherein the customer care infrastructure is further adapted to
parse a status information query for subscriber information;
determine a subscriber's home location register from the subscriber information;
query the subscriber's home location register to identify the mobile telephone switching office on which the subscriber is active;
issue a presence information query to the mobile telephone switching office; and
receive and process location information from the mobile telephone switching office.
